(19) United States
(12) Patent Application Publication
(10) Pub. No.: US 2012/0052182 A1
(43) Pub. Date: Mar. 1, 2012

(54) BEVERAGE

(75) Inventors: Victor Behrmann, Brussels (BE); Mairtin O'Coinceanainn, Brussels (BE)

(73) Assignee: The Coca-Cola Company, Atlanta, GA (US)

(21) Appl. No.: 13/265,474

(22) PCT Filed: Apr. 14, 2010
(86) PCT No.: PCT/US10/31013

§ 371 Date: Oct. 20, 2011

(30) Foreign Application Priority Data
Apr. 20, 2009 (GB) 0906723.2

(51) Int. Cl. A23L 2/52; A23F 5/24; A23G 1/56; A23F 3/00; A23L 2/02; A23C 9/18; A23C 13/08; A23C 3/02; A23L 2/46; A23C 3/08; A23L 2/44

(52) U.S. Cl. 426/583; 426/580; 426/590; 426/594; 426/593; 426/597; 426/599; 426/588; 426/586

(57) ABSTRACT

The invention relates to a beverage comprising a plant extract and/or a dairy product, and an amount of an ammonium-salt capable of maintaining the pH of the beverage at a predetermined pH. The invention also relates to methods and uses of an ammonium-salt in maintaining the pH of a beverage.

The invention relates to a beverage comprising a plant extract and/or a dairy product, and an amount of an ammonium-salt capable of maintaining the pH of the beverage at a predetermined pH. The invention also relates to methods and uses involving an ammonium-salt to maintain the pH of a beverage.

There are many different types of beverages (such as hot, cold and alcoholic beverages), which have different aromas and tastes (such as sweetness, mellowness, bitterness, body and acidity). For example, there are many species of coffee (for example, ranging from low-grade robustas to high-grade arabicas) and many types of tea, which differ in their aroma, texture and taste. Typically, consumers select, and display a preference for, a certain beverage (or types of beverage) depending on the aroma, texture and taste.

It is known that the aroma, texture and taste of a beverage is affected by its pH and, accordingly, pH can directly influence the consumer's preference for, and enjoyment of, particular beverages. That can be important because, for example, if a usually-preferred beverage has an unusual or altered pH, the consumer may experience an unanticipated or unpleasant taste, texture and/or aroma, and the consumer's dissatisfaction may prevent selection of that beverage in the future.

Non-carbonated canned beverages may be generally classified as either “acid beverages”, having a pH of less than 4.60 (such as fruit drinks, sports drinks etc) or “low-acid beverages”, having a pH of 4.60 to around pH 7 (such as coffee, tea, soup and other beverages containing plant extracts). Beverages having a pH of 4.60 or above when manufactured (such as low-acid beverages) must be sterilised in order to destroy any micro-organisms transferred from the raw ingredients used to make the beverage, which typically involves heat sterlisation at 100° C. or more.

Acid beverages and low-acid beverages generally undergo a decrease in pH during heat sterilisation or during long-term storage in heated conditions (such as in vending machines, which may retain beverages at 40° C. to 60° C.). A decrease in pH can lead to an undesirable acid taste and a deterioration in the quality of taste, texture and aroma of the beverage.

Particular problems are encountered with the heat treatment of beverages containing dairy products (such as coffee or tea with milk). On heating, lactose compounds present in milk generate organic acids and tertiary phosphates precipitate with the subsequent release of protons (H⁺ ions), leading to acidification of the beverage.

Problems are also encountered with the heat treatment of beverages containing plant extracts such as coffee extracts. Coffee is a rich source of ester compounds which are hydrolysed on heating, leading to the production of corresponding organic acids (for example, the hydrolysis of chlorogenic acid will produce cinnamic acid and quinic acid) and acidification of the beverage.

Problems are also encountered during acidification of milk-containing beverages. As the beverage pH approaches the isoelectric point of individual milk lactoproteins, those lactoproteins typically precipitate leading to milk separation, degradation and deterioration which results in a beverage having an unpleasant taste, texture and aroma and which is visually unappealing to consumers.

Conversely, it is recognised that too little acidity in certain beverages (such as coffee-based beverages) can cause a “flat” flavour profile, which is not desirable for the consumer.

Accordingly, it is desirable for beverages to retain an appropriate pH during manufacture, sterilisation and storage, so that unpleasant taste, texture and/or aroma is avoided.

Various attempts have been made to address the above problems.

U.S. Pat. No. 6,482,456 relates to a method of producing a low-acid beverage in which chitosan, chitosan oligosaccharide and/or glucosamine is added to the beverage to minimise pH decrease and the associated deterioration of quality.

WO 96/28038 relates to a method of treating coffee prior to domestic or commercial brewing of a ground or roasted form of the coffee to form a beverage, in order to lower the acidity of the resulting beverage. Treatment prior to brewing significantly affects the composition of coffee solids in the ground or roasted coffee such that, when the beverage is subsequently brewed, additional compounds (such as quinic and phenolic acids) are formed in the beverage which give an unpleasant taste, texture and/or aroma.

U.S. Pat. No. 6,056,989 relates to a study of ionic species in beverages, which identified the presence of inorganic ions such as sodium, potassium, calcium, carbonate and phosphate in the raw ingredients for various drinks. As a result of those studies, beverage pH was adjusted with sodium salts or potassium salts in an attempt to prevent a reduction in pH and the associated deterioration of aroma and taste.

However, the use of sodium-salts (such as sodium bicarbonate and disodium hydrogenphosphate) for pH adjustment can cause saltiness, sliminess and a bad after-taste in beverages, which results in the deterioration of their characteristic aromas and tastes. Potassium-salts, whilst exhibiting fewer adverse effects than sodium-salts, are not recognised as an acceptable beverage supplement by global food legislation, prohibiting their use in several major markets.

Accordingly, there is a need for methods and beverage supplements that prevent the formation of acid compounds in the beverage when it is heat-sterilised, re-heated and/or during storage in a heated condition, and which result in a deterioration of taste, texture and/or aroma of the beverage.

The above problems are addressed by the present invention.

In a first aspect, the invention provides a beverage comprising a plant extract and/or a dairy product, and an amount of an ammonium-salt capable of maintaining the pH of the beverage at a predetermined pH.

In a second aspect, the invention provides a beverage comprising a plant extract and/or a dairy product, and an amount of an ammonium-salt capable of adjusting the pH of the beverage to a predetermined pH.

As discussed above, it is known that maintaining the pH of a beverage at a desired, predetermined level and/or adjusting the pH of a beverage to a desired, predetermined level, reduces and/or prevents the deterioration of taste, texture and aroma of the beverage (for example, following heat sterilisation of the beverage or beverage storage in a heated condition). However, as discussed above, the task of maintaining a predetermined pH and/or adjusting the pH, of a beverage comprising a plant extract and/or a dairy product is complicated because alkaline pH adjustors can have a deleterious effect on the taste, texture and/or aroma of the beverage.

As described herein, the above problems can be addressed by the present invention. In the first aspect, the invention provides a beverage comprising an amount of an ammonium-salt capable of maintaining the pH of the beverage (such as coffee) at a predetermined pH. Thus, in the first aspect, the ammonium-salt can be used to maintain the pH of the beverage to which it is added. As demonstrated in the accompanying Examples, the addition of ammonium-salt effectively maintains the beverage at a predetermined pH and the ammonium salt is not thought to lead to the formation of any novel flavour compounds when added to a beverage comprising a plant extract and/or a dairy product, so it does not adversely alter the aroma, texture and/or taste of the beverage.

In the second aspect, the invention provides a beverage comprising an amount of an ammonium-salt capable of adjusting the pH of the beverage (such as coffee) to a predetermined pH. Thus, in the second aspect, the ammonium-salt can be used to adjust the pH of the beverage to which it is added, resulting in the beverage pH being adjusted to a predetermined pH. Such adjustment can be advantageous, for example, where a beverage has an undesirable pH when manufactured and which needs to be adjusted to a preferred, predetermined pH.

In other words, the invention relates to a beverage comprising an ammonium-salt as an active ingredient to maintain the beverage pH at a predetermined pH and/or to adjust the beverage pH to a predetermined pH

The inventors' discovery is surprising given that ammonium-based compounds are generally well-known to exhibit strong aroma. It had previously been thought likely that ammonium-salt would react with compounds in a beverage comprising a plant extract and/or a dairy product, leading to the formation of ammonium-based compounds which adversely affect the aroma, texture and/or taste of the beverage.

Preferably, the ammonium-salt is any ammonium-salt having an alkali counter ion. It is particularly preferred that the ammonium-salt is one or more salt selected from the group consisting of: ammonium carbonate; ammonium carbamate; ammonium bicarbonate; ammonium alginate; ammonium dihydrogen phosphate; ammonium hydrogen carbonate. The ammonium-salt should be acceptable for use in food and drink applications (for example, of an acceptable quality and purity), and thereby be acceptable for consumption by a person, and such ammonium-salts are known to those skilled in the art.

In one embodiment, the beverage of the first or second aspect of the invention contains other materials capable of maintaining and/or adjusting the pH of the beverage at the predetermined pH in addition to the ammonium-salt. For example, the beverage may contain sodium-salts (such as sodium bicarbonate and disodium hydrogenphosphate) and/or potassium-salts (such as potassium bicarbonate) and/or chitosan, chitosan oligosaccharide and/or glucosamine in addition to the ammonium-salt. As discussed above, such materials may also contribute to the maintenance and/or adjustment of the predetermined pH of a beverage, reducing the deterioration of aroma, taste and/or texture of the beverage.

As demonstrated in the accompanying Examples however, ammonium-salt alone is capable of maintaining and/or adjusting the pH of the beverage at the predetermined pH. Accordingly, in an alternative embodiment, the beverage does not contain any other materials capable of maintaining the pH of the beverage at the predetermined pH other than the ammonium-salt. For example, in that embodiment, the beverage does not contain sodium-salts (such as sodium bicarbonate and disodium hydrogenphosphate) and/or potassium-salts (such as potassium bicarbonate) and/or chitosan, chitosan oligosaccharide and/or glucosamine in an amount capable of maintaining the pH of the beverage at the predetermined, desired pH.

By “beverage” we include a liquid that is prepared, and is suitable for, human consumption by drinking. The beverage may be consumed when it is at a hot temperature (for example, where the beverage temperature is between approximately 30° C. and 60° C. or more) and/or when it is at a cold temperature (for example, where the beverage temperature is between approximately 4° C. and 29° C.).

In a particularly preferred embodiment, the beverage is a ready-to-drink beverage, meaning that the beverage is supplied in a pre-prepared form suitable for consumption and does not require any additional ingredients before it is consumed.

In a particularly preferred embodiment, the ready-to-drink beverage may be a ready-to-drink milk-coffee beverage (i.e. a beverage comprising milk or a milk product, and coffee or a coffee extract, for example as discussed below and in the accompanying Examples).

In one embodiment, the ready-to-drink beverage may be supplied at a suitably cold temperature for consumption (for example, at a beverage temperature of between approximately 4° C. and 29° C.).

In an alternative embodiment, the ready-to-drink beverage may be supplied at a suitably hot temperature for consumption (for example, at a beverage temperature of between approximately 30° C. and 60° C. or more).

Preferably, the beverage (such as a ready-to-drink beverage) has been sterilised, for example by heat treatment, thereby destroying and/or removing micro-organisms from the beverage and ensuring microbiological stability of the beverage. Suitable heat sterilisation approaches are discussed below and include, for example, retort sterilisation and pasteurisation.

Preferably, the beverage (such as a ready-to-drink beverage) is a re-heatable beverage. By “re-heatable” we include the meaning that, after the hot beverage has cooled, it can be returned to a hot temperature (i.e. re-heated) without resulting in a reduction in pH, leading to an unpleasant taste, texture and/or aroma. In a preferred embodiment, the beverage is a re-heatable, ready-to-drink, sterilised, milk-coffee beverage.

Even more preferably, the beverage of the invention is a sterilised milk-coffee beverage (i.e. a beverage comprising milk or a milk product, and coffee or a coffee extract), and is most preferably a ready-to-drink, sterilised, milk-coffee beverage which is supplied to the consumer as a cold beverage (i.e. at a temperature of approximately 4° C. and 29° C.).

It is well known that the perceived taste, aroma and/or texture (texture is also referred to as “mouthfeel”) of a beverage are amongst the key characteristics contributing to sensorial pleasure of a beverage. Any beverage ingredient and/or step in beverage manufacture or storage which contributes to a deleterious effect on any of those parameters can result in an overall unacceptable (or even unpalatable) beverage.

Methods for assessing and/or measuring the taste, aroma and texture of a beverage are known in the art, such as those described in U.S. Pat. No. 6,056,989, which methods are incorporated herein by reference.

The accompanying Examples describe methods for determining the taste, aroma and/or texture of a beverage. In those methods, a person skilled in the art of beverage-tasting provides an evaluation of the taste, texture (i.e. mouthfeel) and aroma of a test beverage.

pH is a logarithmic scale for expressing the acidity or alkalinity of a solution at a given 220 temperature (typically at 22° C. or 25° C.). Acidity is a measure of the concentration of hydrogen ions in a solution which impart acidity. In a water solution, a hydrogen ion is an atom of hydrogen with a positive charge due to a loss of an electron (designated: H⁺). To measure H⁺ concentration, an electrode is immersed in the water solution to give a reading in pH units. The pH is defined as the logarithm (to the base 10) of the reciprocal of hydrogen ion concentration

A pH below 7 indicates an acid solution; a pH of 7 indicates a neutral solution; and a pH above 7 indicates an alkaline solution. Examples of pH are pH 1 for a 0.36% solution of hydrochloric acid (a strong acid) and pH 13 for a 0.40% solution of sodium hydroxide (a strong base). Vinegar has a pH of about 3; milk has a pH of about 6.65 to 6.80; pure water has a pH of about 7; sea water has a pH of about 8.50 to 10.

Since pH is an exponential function, what may appear to be a small numeric change may represent a very large change in the concentration of hydrogen ions (as compared to the hydroxyl ions (OH⁻)). The change in acidity of a solution resulting from a particular treatment may be expressed as a percentage of pH of the treated solution compared to the pH of the untreated solution.

Preferably, a beverage for use in the invention is one that usually undergoes a reduction in pH (i.e. an increase in acidity) during heat sterlisation and/or during long-term storage in a heated condition, which reduction in pH alters and adversely affects the aroma, texture and/or taste of the beverage. As discussed above, in the first aspect of the invention, such a beverage is treated such that it comprises an amount of an ammonium-salt capable of maintaining the beverage at a predetermined, desired pH (for example, by maintaining the beverage at the original beverage pH when manufactured) and thereby reducing and/or preventing the previous adverse alteration of beverage aroma, texture and/or taste. Alternatively, in a second aspect of the invention, such a beverage is treated such that it comprises an amount of an ammonium-salt capable of adjusting the beverage at a predetermined, desired pH (for example, by returning the beverage to the original beverage pH exhibited prior to its sterilisation and/or storage) and thereby reducing and/or preventing the previous adverse alteration of beverage aroma, texture and/or taste.

As discussed above, it is particularly important to maintain and/or adjust the pH at a predetermined pH of a beverage which comprises a plant extract and/or a dairy product.

Whole milk has a pH in the range of 6.65 to 6.80, and any decrease in pH to pH 5.90 or below (i.e. approaching the isoelectric point of individual lactoproteins in milk) can result in the formation and precipitation of milk components (such as individual lacto-proteins and insoluble calcium phosphate), which adversely affect the taste, texture (i.e. mouthfeel), aroma and appearance of the resulting beverage.

For example, the pH of whole milk changes with the addition of additional beverage ingredients (such as plant extracts like coffee extract, concentrates and/or salts), resulting in the pH varying from the normal pH of highest stability in milk (i.e. pH 6.65 to 6.80). During subsequent heating of such a milk-containing beverage (such as milk-coffee) a number of key chemical transformations occur, with a decrease in pH contribution from both the milk and the coffee component (for example, hydrolysis of esters present in coffee) together with the transfer of soluble calcium phosphate to insoluble calcium phosphate. This adversely affects the taste, texture and aroma of the beverage and can be addressed by adjusting the pH of the beverage.

In a preferred embodiment, the beverage is a milk-coffee beverage (i.e. a beverage comprising milk or a milk product, and coffee or a coffee extract) and has a pH of pH 6 or above when manufactured (for example, between pH 6.40 to 6.90). Typically such beverages exhibit a pH decrease to pH 5.90 or below during heat sterlisation and/or long-term storage in a heated condition. The beverage of the invention (which comprises an amount of an ammonium-salt capable of maintaining the pH of the beverage to a predetermined pH or maintaining the predetermined pH of the beverage) does not undergo a pH decrease to pH 5.90 or below during heat sterlisation and/or long-term storage in a heated condition, thereby preventing precipitation of milk components and maintaining the desirable taste, texture, aroma and appearance of the beverage.

In a preferred embodiment, the beverage when manufactured has a pH of, for example:
pH 6 or above; pH 6.40 or above; pH 6.50 or above; pH 6.60 or above; pH 6.80 or above; pH 6.90 or above; pH 7 or above;
or a pH of: pH 6; pH 6.40; pH 6.50; pH 6.60; pH 6.65; pH 6.70; pH 6.80; pH 6.90; pH 7; pH 8;
or a pH range from: pH 6 to pH 8; pH 6 to pH 7; pH 6.65 to pH 6.80; pH 6.90.

Typically, during heat sterlisation and/or long-term storage in a heated condition, the pH of such beverages decreases to, for example, a pH of:
pH 5.90 or below, pH 5.80 or below; pH 5.70 or below; pH 5.60 or below; pH 5.50 or below; pH 5 or below; pH 4 or below; pH 3 or below;
or a pH of: pH 5.90, pH 5.80; pH 5.70; pH 5.60; pH 5.50; pH 5 pH 4; pH 3;
or a pH range from pH 5.90 to pH 3; pH 5.80 to pH 3; pH 5.70 to pH 3; pH 5.60 to pH 3; pH 5.50 to pH 3; pH 5 to pH 3; pH 4 to pH 3.

However, the pH of such beverages which comprise an amount of an ammonium-salt capable of maintaining the pH of the beverage at a predetermined pH does not undergo a pH decrease to pH 5.90 or below during heat sterlisation and/or long-term storage in a heated condition, thereby preventing deterioration of the taste, texture, aroma and/or appearance of the beverage of the invention.

In a preferred embodiment, the beverage has a pH of pH 6 or above when manufactured (for example, between pH 6.40 to 6.90), such as a milk-coffee beverage (i.e. a beverage comprising milk or a milk product, and coffee or a coffee extract). Such beverages typically undergo a pH decrease to pH 5.90 or below during heat sterlisation and/or long-term storage in a heated condition. However, preferably the pH of such beverages which comprise an amount of an ammonium-salt capable of maintaining the pH of the beverage at a predetermined pH does not undergo a pH decrease to pH 5.90 or below during heat sterlisation and/or long-term storage in a heated condition, thereby preventing deterioration of the taste, texture, aroma and/or appearance of the beverage of the invention.

As discussed in the accompanying Examples, one preferred beverage of the invention (referred to as “Product 1”) has a pH of 6.90 when manufactured and a predetermined, desired pH of 6.40 after heat treatment (e.g. retort sterilisation), whilst another preferred beverage of the invention (referred to as “Product 3”) has a pH of 6.90 when manufactured and a pH of 6.55 after heat treatment (e.g. retort sterilisation).

Unless otherwise stated herein, the pH value of the beverage for use in the invention is determined at a temperature of 22° C. and at one atmospheric pressure.

As discussed above, in a first aspect of the invention, the ammonium-salt is capable of maintaining the predetermined pH of the beverage. Thus, in the first aspect of the invention, the beverage comprises an amount of ammonium-salt which is capable of acting as a buffer in order to maintain the pH of the beverage at the predetermined, desired pH.

It is well known that buffers comprise a solution of one or more salt of a weak acid, and which is capable of neutralising additional acids and bases and acts to maintain the pH of a solution. A buffered solution contains both a weak acid and its conjugate weak base and its pH changes are minimal upon the addition of small amounts of acid or base to the solution.

In the context of the present invention, adding a buffer to a beverage effectively neutralises additional acids formed during or following heat treatment of the beverage, thereby maintaining the pH of the beverage by preventing and/or minimising increases or decreases in pH.

By “maintaining the predetermined pH of the beverage” we include the meaning that the ammonium-salt prevents and/or minimises increases or decreases in pH of the beverage away from the predetermined pH, for example by neutralising additional acids formed during or after heat treatment of the beverage.

The predetermined pH may vary between different beverage types and can be selected by a person skilled in the art based on the range or value of pH associated with a desirable or optimal taste, texture and/or aroma (which can be tested by those skilled in the art, as discussed above).

For example, as discussed above, the predetermined pH of a beverage may be pH 6 or above; pH 6.40 or above; pH 6.50 or above; pH 6.60 or above; pH 6.80 or above; pH 6.90 or above; pH 7 or above, or may lie within a pH range from: pH 6 to pH 8; pH 6 to pH 7; pH 6.65 to pH 6.80. In the case of a milk-coffee beverage (i.e. a beverage comprising milk or a milk product, and coffee or a coffee extract), the predetermined pH may be a pH range of 6.40 to 6.90.

Thus “maintaining the predetermined pH of the beverage” includes the meaning that the ammonium-salt prevents the pH of the beverage from reaching a level that adversely affects the taste, texture, aroma and/or appearance of the beverage. For example, “maintaining the predetermined pH of the beverage” also includes the meaning that the ammonium-salt prevents the pH of the beverage from decreasing to pH 5.90 or below.

By “maintaining the predetermined pH of the beverage” we also include the meaning that the ammonium-salt maintains the pH of the beverage a pH value of 0.01 of the predetermined pH, or a pH value of 0.02 or 0.03 or 0.04 or 0.05 or 0.06 or 0.07 or 0.08 or 0.09 or 0.10 or 0.20 or 0.30 or 0.40 or 0.50 or 0.60 or 0.70 or 0.80 or 0.90 of the predetermined pH.

As discussed above, maintaining and/or stabilising the pH of a beverage at a desired, predetermined level following heat treatment reduces and/or prevents the deterioration of taste, texture and aroma of the beverage after its sterilisation or long-term storage in a heated condition.

As demonstrated in the accompanying Examples, ammonium-salt is capable of maintaining the pH of a beverage at a desirable, predetermined pH. That discovery is surprising because, as the beverages of the invention (such as those containing plant extracts and/or dairy products) do not generally contain ammonium ions, the addition of ammonium-salt would not generally be expected to form a buffering system capable of maintaining a predetermined pH in the beverage.

Without wishing to be bound by theory, it is thought that, following its addition to a beverage, the ammonium-salt dissociates in the beverage into ammonium ions (i.e. NH₄⁺) and corresponding alkaline counter-ions, thereby forming a buffering system capable of maintaining a predetermined pH in the beverage. Accordingly, in an embodiment, the invention provides a beverage comprising a plant extract and/or a dairy product, and an amount or concentration of ammonium ions capable of adjusting and/or maintaining the pH of the beverage to a predetermined pH.

Preferably, the invention provides a beverage wherein maintaining the predetermined pH of the beverage comprises preventing and/or reducing acidification of the beverage. By “acidification of the beverage” we include the increase in concentration of H⁺ ions in the beverage, which leads to an increase in acidity in the beverage (i.e. measured as a lowering of pH). Thus, in the context of the present invention, by preventing and/or reducing acidification of the beverage, the predetermined pH of the beverage is maintained.

Conveniently, the predetermined pH is maintained during and/or after the beverage is subjected to heat treatment.

As discussed above, certain beverages (such as low-acid beverages) must be sterilised, typically by heat sterilisation, in order to destroy, remove and/or reduce any micro-organisms transferred from the raw ingredients used to make the beverage. Such micro-organisms may be pathogens and/or spoilage organisms, and their removal and/or reduction results in a safe and shelf-stable beverage.

The particular micro-organisms to be destroyed will be dependent on intrinsic factors (such as the initial number of micro-organisms present in each of the individual beverage ingredients) and extrinsic factors (such as the level and rate of growth of different types of micro-organisms in the resulting product).

It will be appreciated that the required sterilisation procedure can be determined by calculating the initial number of micro-organisms (i.e. microbial load in the individual beverage ingredients), the defined end-level of micro-organism growth, and the kinetics required to inactivate the micro-organism concerned.

It is possible to calculate the lethal effect of the exposure of a microbial population to a variable temperature “T” by relating it to an hypothetical sterilisation performed at a constant temperature “To” for the time “to”. If the constant temperature is assumed equal to 121.11° C., the term “Fo” is the equivalent exposure time at 121.11° C. of the actual exposure at a variable temperature, calculated for an ideal micro-organism and can be calculated from the formula:

$${F}_{0} = Δ t \sum {10}^{\frac{T - 121}{10}}$$

So for example, if sterilisation is usually performed for 20 minutes at 111° C., the period required at 121.11° C. will be 2 minutes:

$${F}_{0} = 20 * {10}^{\frac{111 - 121}{10}} = 20 * {10}^{\frac{- 10}{10}} = {20}^{- 1} = 2 min$$

In a preferred embodiment, the heat sterilisation is performed to give an F₀ value of between 3 and 80, such as an F₀ value of 3 or 5 or 10 or 20 or 30 or 40 or 50 or 60 or 70 or 80.

It will be appreciated that different heat sterilisation conditions can be performed to give a particular F₀ value. For example, an F₀ value of 80 can be achieved by performing sterilisation at 121° C. for 80 minutes or at 124° C. for 40 minutes.

Typically, heat treatment comprises or consists of retort sterilisation or pasteurisation.

Retort sterilisation is a steam-based sterilisation process used for sterilising food, nutraceutical and pharmaceutical products. Several types of retort sterilisation are known, which use steam as either the direct heating media (for example, saturated steam) or as the indirect heating media (for example, steam-heated water used in a water immersion process), for example:
Saturated Steam type retort sterilisation (involving direct-steam heating);
Water Immersion type retort sterilisation (which may be rotary or static heating and involves indirect steam heating);
Water Spray type retort sterilisation (which may be rotary or static heating and involves indirect steam heating);
Steam-Air type retort sterilisation (which may be rotary or static heating and involves direct steam heating).

The precise parameters used in retort sterilisation vary widely depending on the product to be treated and the country in which sterilisation is performed (different countries often specify different retort conditions). For example, retort sterilisation may be performed at 125° C. for 25 min, or at 121° C. for 20 to 25 min.

Suitable conditions for performing retort sterilisation are well known in the art and are described, for example, in Campden and Chorleywood Food Research Association (CCFRA) Guideline no. 13 (1997; “Guidelines for Batch Retort Systems—full water immersion—raining spray water processing”) which is incorporated herein by reference. Accordingly, those skilled in the art would be capable of selecting appropriate conditions for retort sterilisation of a beverage of the invention.

Pasteurisation typically uses temperatures below boiling as it is generally used to sterilise milk and, at above boiling point, casein micelles in milk may irreversibly aggregate (or “curdle”).

Several types of pasteurisation are known and are suitable for use with the beverage of the invention.

High Temperature/Short Time (HTST) pasteurisation involves forcing the liquid to be treated between metal plates or through pipes heated on the outside by hot water, where the liquid is heated to 71.7° C. (161° F.) for 15-20 seconds. Double pasteurisation involves heating the liquid to 72° C. (161° F.) for two separate 15-second periods, instead of one 30-second period as was the current standard.

Extended Shelf Life (ESL) treatment involves a microbial-filtration step and heating at a lower temperature than HTST.

Ultra-High Temperature (UHT or ultra-heat treated; also known as ultra-pasteurisation) sterilisation may also be used, and involves heating the liquid to a temperature of 138° C. (250° F.) for a fraction of a second.

Batch pasteurisation involves heating large batches of milk to a lower temperature, typically 63° C. (145° F.) for 30 minutes, followed by quick cooling to about 4° C. (39° F.).

Conveniently, the pH of the beverage of the invention is maintained when the beverage is subjected to long-term storage in a heated condition. The beverage of the invention may be subjected to such conditions when provided in a vending machine. It is well known that vending machines which supply ready-to-drink hot beverages to consumers maintain a reservoir of pre-made beverage at the required hot temperature for consumption (for example, at a beverage temperature of between approximately 30° C. and 60° C.) so that the beverage can be rapidly dispensed to the consumer at the required hot temperature and immediately consumed if desired. The reservoir of pre-made beverage may be stored at the hot temperature in the vending machine for a substantial period of time before being dispensed (for example, hours, days or weeks) and it is important that the pH of the beverage is maintained during that period so that the intended taste, texture, aroma and appearance of the beverage are retained when it is dispensed.

The conditions at which beverages are stored in vending machines vary depending on geographical location—for example, vending machines in Europe typically retain hot beverages at a temperature of between 30° C. to 40° C., whilst vending machines in Asia typically retain hot beverages at a temperature of between 40° C. to 50° C. or 40° C. to 60° C.

Thus, by “long-term storage in a heated condition” we include the storage of a beverage at a temperature of 30° C. or more (for example, 40° C. or 45° C. or 50° C. or 55° C. or 60° C. or more, such as between 30° C. and 40° C.; or between 30° C. to 50° C.; or between 30° C. to 60° C.; or between 40° C. to 50° C.; or between 40° C. to 60° C.; or between 50° C. to 60° C.) and for a period of one hour or more (for example, 2 hours or 3 hours or 4 hours or 5 hours or 6 hours or 7 hours or 8 hours or 9 hours or 10 hours or 11 hours or 12 hours or 13 hours or 14 hours or 15 hours or 16 hours or 17 hours or 18 hours or 19 hours or 20 hours or 21 hours or 22 hours or 23 hours or 24 hours or 2 days or 3 days or 4 days or 5 days or 6 days or one week or two weeks or three weeks).

For example, we include the storage of the beverage at:
a temperature of 30° C. for one hour or 2 hours or 3 hours or 4 hours or 5 hours or 6 hours or 7 hours or 8 hours or 9 hours or 10 hours or 11 hours or 12 hours or 13 hours or 14 hours or 15 hours or 16 hours or 17 hours or 18 hours or 19 hours or 20 hours or 21 hours or 22 hours or 23 hours or 24 hours.
a temperature of 40° C. for one hour or 2 hours or 3 hours or 4 hours or 5 hours or 6 hours or 7 hours or 8 hours or 9 hours or 10 hours or 11 hours or 12 hours or 13 hours or 14 hours or 15 hours or 16 hours or 17 hours or 18 hours or 19 hours or 20 hours or 21 hours or 22 hours or 23 hours or 24 hours.
a temperature of 50° C. for one hour or 2 hours or 3 hours or 4 hours or 5 hours or 6 hours or 7 hours or 8 hours or 9 hours or 10 hours or 11 hours or 12 hours or 13 hours or 14 hours or 15 hours or 16 hours or 17 hours or 18 hours or 19 hours or 20 hours or 21 hours or 22 hours or 23 hours or 24 hours.
a temperature of 60° C. for one hour or 2 hours or 3 hours or 4 hours or 5 hours or 6 hours or 7 hours or 8 hours or 9 hours or 10 hours or 11 hours or 12 hours or 13 hours or 14 hours or 15 hours or 16 hours or 17 hours or 18 hours or 19 hours or 20 hours or 21 hours or 22 hours or 23 hours or 24 hours.

Conveniently, the predetermined pH of the beverage of the invention is maintained when the beverage is subjected to storage for such periods in a heated condition.

In a preferred embodiment, the invention provides a beverage wherein the plant extract is an extract which, on heat sterilisation or long-term storage in a heated condition, produces an acid through ester hydrolysis or H⁺ (hydrogen ion) release. For example, the plant extract may be selected from the group comprising or consisting of: a coffee extract; a cocoa extract; a tea extract; a cereal extract; a vegetable extract; a fruit extract; a herb extract; or any such extract capable of producing an acid through ester hydrolysis or H⁺ release when subjected to heat sterilisation or long-term storage in a heated condition.

Preferably, the beverage is a non-carbonated beverage.

By “a plant extract” we include any solid, liquid or aqueous material extracted from any part of the plant (such as the leaf, root, seed, bean, fruit or flower). For example, by a coffee extract we include material extracted from a coffee plant, particularly an extract from the bean of the coffee plant. Such extracts may be treated prior to inclusion in a beverage of the invention (for example, a coffee bean may be roasted prior to inclusion in a beverage).

By “a dairy product” we include milk (such as milk from a cow, or from another mammal such as a goat, sheep, water buffalo, yak or horse) and products manufactured from milk. In one embodiment, the invention provides a beverage wherein the dairy product is milk or milk-based protein or milk isolate, for example as described in Advanced Dairy Chemistry (3^{rd} Edition; edited by PF Fox, PLH McSweeney; Springer pub., 2003 ISBN 0306472716, 9780306472718), which is incorporated herein by reference.

Preferably, the dairy product is selected from the group comprising: milk (including whole milk, semi-skimmed milk; skimmed milk; powdered milk; long-life milk); cream (including full-fat cream; half-fat cream; low-fat cream; sour cream; clotted cream); and yoghurt.

It is preferred that the beverage according to the invention is a coffee beverage, such as a coffee beverage selected from the group comprising or consisting of: black coffee; milk-coffee (also called white coffee, of which there are many known types, including cappuccino); ice-coffee.

In one embodiment, the beverage according to the invention is a tea beverage, such as a tea beverage selected from the group comprising or consisting of: black tea; milk-tea (also called white tea); ice-tea; green tea, oolong tea; blended tea.

In one embodiment, the beverage according to the invention is a milk beverage, such as a milk beverage selected from the group comprising or consisting of: milk; cream; milk-shake.

In one embodiment, the beverage according to the invention is a cocoa beverage, such as a cocoa beverage selected from the group comprising or consisting of: chocolate drink; hot chocolate; cocoa; chocolate-coffee drink (such as chocolate-flavoured coffee cappuccino drinks).

Preferably, where the beverage is a coffee beverage, the predetermined pH of the beverage is pH 6 or above (for example, between pH 6.40 to 6.90, such as pH 6.55).

In one embodiment, the ammonium-salt comprises or consists of ammonium carbonate. Ammonium carbonate suitable for addition to the beverage of the invention include a 10% solution of ammonium carbonate having a pH of 9.0.

In a preferred embodiment, the invention provides a beverage wherein the ammonium-salt comprises or consists of ammonium bicarbonate. Ammonium bicarbonate suitable for addition to the beverage of the invention include a 10% solution of ammonium bicarbonate having a pH of 7.8.

Preferably, the invention provides a beverage comprising or consisting of the following ingredients: (expressed as weight in a total volume of 2 litres (i.e. w/v)):
Milk: 0.0 grams to 1800 grams
Coffee solids: 1.0 gram to 100 grams
Cocoa solids: 0.0 grams to 25 grams
Ammonium bicarbonate: 0.2 grams to 9.0 grams
Potassium citrate: 0.0 grams to 2.0 grams
Potassium phosphate: 0.0 grams to 3.0 grams
Stabiliser (from cellulose gum/microcrystalline cellulose and carrageenan): 0.0 grams to 60 grams
Water to a total volume of 2 litres.

In one particularly preferred embodiment, the invention provides a beverage comprising, essentially comprising, or consisting of the following ingredients (as a percentage of weight per volume (i.e. w/v)):
Coffee solids/extract: 1%
Cocoa solids/extract: 0.2%
Milk: 35%
Ammonium bicarbonate: 0.095%
Potassium citrate: 0.1%
Potassium phosphate: 0.095%
Sugar: 4.8%
Water to 100% volume
Optionally, a stabiliser (from cellulose gum/microcrystalline cellulose and carrageenan) may also be included in an amount of 0.0 grams to 30 grams per litre.

As described in the accompanying Examples (in which the beverage is referred to as “Product 1”), such a beverage has a pH of approximately 6.90 before heat sterilisation (i.e. by retort sterilisation) and a pH of approximately 6.40 after retort treatment.

In another particularly preferred embodiment, the invention provides a beverage comprising, essentially comprising, or consisting of the following ingredients (as a percentage of weight per volume):
Coffee solids/extract: 1%
Cocoa solids/extract: 0.2%
Milk: 75%
Ammonium bicarbonate: 0.3%
Sugar: 3%
Water to 100% volume
Optionally, a stabiliser (from cellulose gum/microcrystalline cellulose and carrageenan) may also be included in an amount of 0.0 grams to 30 grams per litre.

As described in the accompanying Examples (in which the beverage is referred to as “Product 3”), such a beverage has a pH of approximately 6.90 before heat sterilisation (i.e. by retort sterilisation) and a pH of approximately 6.55 after retort treatment.

In a third aspect, the invention provides a method for maintaining the pH of a beverage comprising a plant extract and/or a dairy product, comprising the step of adding to the beverage an amount of an ammonium-salt capable of maintaining the pH of the beverage at a predetermined pH.

In a fourth aspect, the invention provides a method for adjusting the pH of a beverage comprising a plant extract and/or a dairy product, comprising the step of adding to the beverage an amount of an ammonium-salt capable of adjusting the pH of the beverage to a predetermined pH.

As discussed above, it is known that adjusting and/or stabilising the pH of a beverage at a desired, predetermined level reduces and/or prevents the deterioration of taste, texture and aroma of the beverage (for example, following heat sterilisation of the beverage or beverage storage in a heated condition).

Preferably, the beverage of the third and fourth aspect of the invention is one that usually undergoes a reduction in pH (i.e. an increase in acidity) during heat sterlisation and/or long-term storage in a heated condition (as is discussed above in relation to the first aspect of the invention). For example, the beverage may be a “low-acid beverage”, as discussed above.

In a preferred embodiment, the ammonium-salt is capable of maintaining the predetermined pH of the beverage. Thus, in an embodiment, ammonium-salt is added to the beverage in an amount capable of acting as a buffer in order to maintain the pH of the beverage at the predetermined, desired pH.

Preferably, maintaining the predetermined pH of the beverage comprises preventing and/or reducing acidification of the beverage.

It is preferred that the invention provides a method wherein the predetermined pH is maintained when the beverage is subjected to heat treatment, for example heat sterilisation performed to give an F₀ value of between 3 and 80 (such as an F₀ value of 3 or 5 or 10 or 20 or 30 or 40 or 50 or 60 or 70 or 80) as described above. Preferably, the heat treatment is retort sterilisation or pasteurisation or long-term storage in a heated condition (as described above).

As discussed above in relation to the first and second aspects of the invention, stabilising the pH of a beverage at a desired, predetermined level following heat treatment, or during long-term storage of the beverage in a heated condition, reduces and/or prevents the deterioration of taste, texture and/or aroma of the beverage.

In one embodiment, the step in the third and fourth aspects of the invention of adding ammonium-salt to the beverage is performed after manufacture of the beverage but before heat treatment of the beverage (for example, heat treatment by heat sterilisation or long-term storage in a heated condition, as described above).

In an alternative embodiment, the step in the third and fourth aspects of the invention of adding ammonium-salt to the beverage is performed during heat treatment of the beverage (for example, heat treatment by heat sterilisation or long-term storage in a heated condition, as described above).

In one embodiment, the step in the third and fourth aspects of the invention of adding ammonium-salt to the beverage is performed after manufacture and heat treatment of the beverage (for example, heat treatment by heat sterilisation or long-term storage in a heated condition, as described above).

It will be appreciated that the ammonium-salt could be added to the beverage in a number of forms, such as a concentrated or dilute liquid solution of ammonium-salt or as solid granules, powder or capsules of ammonium-salt.

Preferably, the ammonium-salt is provided as a liquid solution of ammonium-salt having an alkali pH, which solution can be simply added to, and dispersed with, the liquid beverage to rapidly and effectively adjust the pH of the beverage. Since concentrated ammonium-salt solutions may be hazardous, preferably a dilute solution of ammonium-salt is used (such as a 10% solution of an ammonium-salt having an alkaline pH), thereby reducing the risk of injury or irritation to any personnel involved in adding the ammonium-salt to the beverage. In a preferred embodiment, the ammonium-salt is provided as a 10% solution of ammonium carbonate having a pH of 9.0, or as a 10% solution of ammonium bicarbonate having a pH of 7.8.

In a preferred embodiment, the invention provides a method wherein the beverage is as defined above in relation to the first or second aspects of the invention.

In an fifth aspect, the invention provides a beverage obtainable by the method according to the third or fourth aspect of the invention. In an sixth aspect, the invention provides a sterile beverage obtainable by the method according to the third or fourth aspect of the invention.

In a seventh aspect, the invention provides a sterile container comprising a sterile beverage of the invention. Preferably, the sterile container is selected from the group comprising or consisting of: a can; a tin; a carton; a bottle; a packet. Such containers are known in the art.

In an eighth aspect, the invention provides the use of an ammonium-salt for maintaining the pH of a beverage comprising a plant extract and/or a dairy product. In a ninth aspect, the invention provides the use of an ammonium-salt for adjusting the pH of a beverage comprising a plant extract and/or a dairy product.

Preferably, in the uses according to the eighth and/or ninth aspect of the invention, the beverage is as defined above in relation to the first or second aspect of the invention.

The listing or discussion of an apparently prior published document in this specification should not necessarily be taken as an acknowledgement that the document is part of the state of the art or is common general knowledge. Preferred, non-limiting examples which embody certain aspects of the invention will now be described, with reference to the following figures.

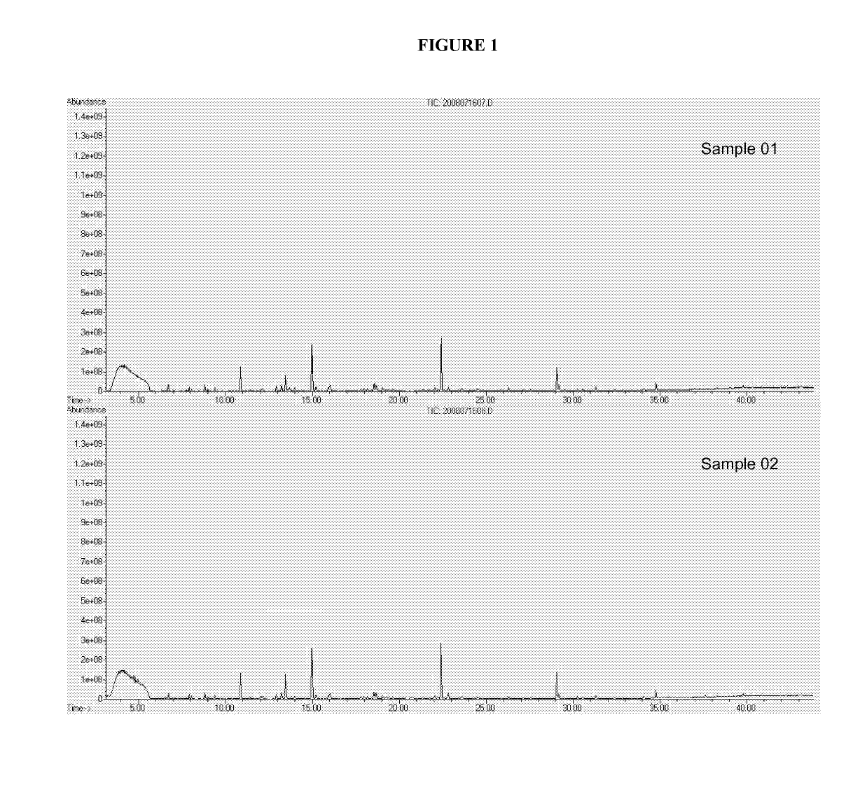

FIG. 1: GC-MS (gas chromatography-mass spectroscopy) analysis of coffee beverages comprising either potassium bicarbonate (Sample 01; top panel) or ammonium bicarbonate (Sample 02; bottom panel), following heat sterilisation by retort heating.
Samples were analyzed by GC-MS with headspace SPME (solid phase micro-extraction), which generates a profile of the volatile and semi-volatile compounds present in the headspace of the liquid or solid sample. In particular, 5 ml of the samples were inserted in a 20 ml headspace vial and heated to 65° C. The volatile compounds were then adsorbed on a SPME fibre for 15 minutes, and the fibre then desorbed in a gas chromatograph with mass spectrometric detection (Agilent 7890 GC-5975C MS).

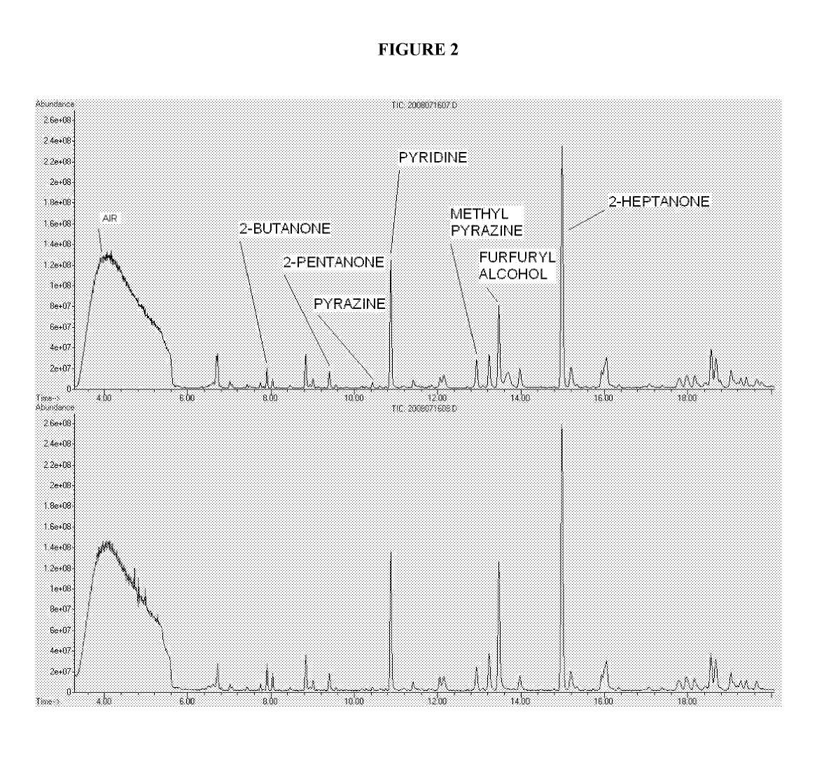

FIG. 2: Annotated GC-MS profiles of the analysis in FIG. 1 (i.e. coffee beverages comprising either a potassium-salt (Sample 01; top panel) or an ammonium-salt (Sample 02; bottom panel), following heat sterilisation by retort heating).

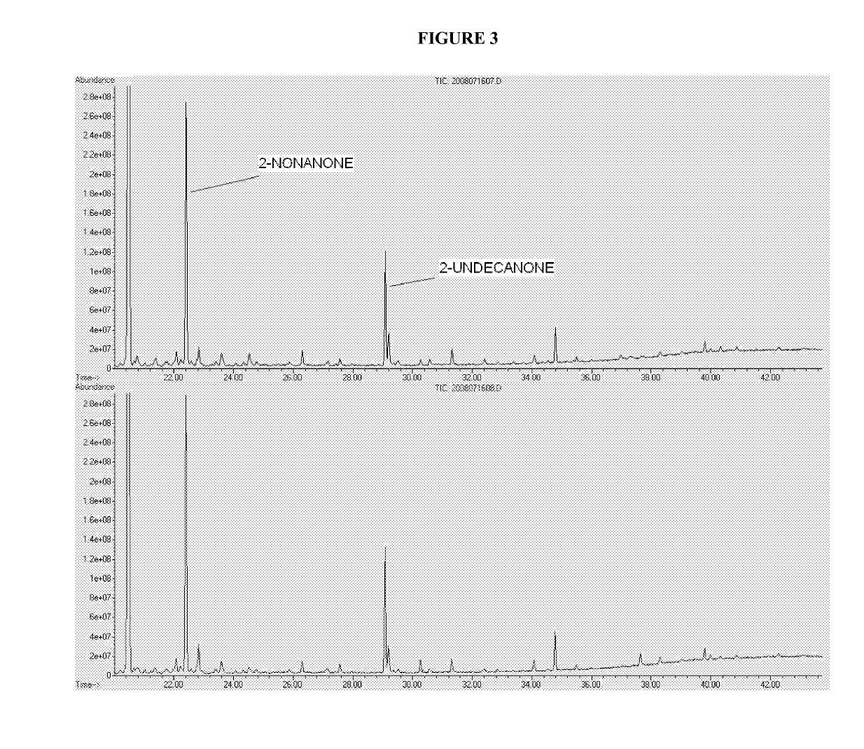

FIG. 3: Annotated GC-MS profiles of the analysis in FIG. 1 (i.e. coffee beverages comprising either a potassium-salt (Sample 01; top panel) or an ammonium-salt (Sample 02; bottom panel), following heat sterilisation by retort heating).

### EXAMPLES

### Example 1

### Exemplary Beverage of the Invention

An exemplary chocolate-flavoured cappuccino beverage is prepared as follows; an aqueous alkaline solution is made up in a vessel by the addition of the following by weight:

| Ingredient | Amount by weight (2 litres) |
|---|---|
| Milk | 0.0 grams to 1800 grams |
| Coffee solids | 1.0 gram to 100 grams |
| Ammonium bicarbonate | 0.2 grams to 9.0 grams |
| Potassium citrate | 0.0 grams to 2.0 grams |
| Potassium phosphate | 0.0 grams to 3.0 grams |
| Cocoa Solids | 0.0 grams to 25 grams |
| Stabiliser (from cellulose | 0.0 grams to 60 grams |
| gum/microcrystalline cellulose | |
| and carrageenan) | |
| Water | To a total volume of 2.0 litres |

The product may be sweetened to the desired requirement with sucrose (or an appropriate sweetener) to the required taste.

The product may be a non-milk beverage (i.e. containing 0.0 grams of milk).

The precise amount of ammonium bicarbonate added to the beverage will vary depending on the level of coffee concentrate/plant material and milk present in the beverage—the precise amount of ammonium-salt required to adjust and maintain the pH of the beverage above pH 6 (for example, after heat treatment) can be can be determined by a person skilled in the art.

In addition to a minimum of 0.2 grams of ammonium bicarbonate, potassium citrate and/or potassium phosphate salts may be added to adjust or maintain the beverage pH.

### Example 2

### Preparation and Testing of Beverages

### Beverage Preparation

The following four chocolate-flavoured cappuccino beverages (“Products 1 to 4”) were prepared in line with Example 1 (all amounts are shown as a percentage of weight to volume):

| Ingredient | Product 1 | Product 2 | Product 3 | Product 4 |
|---|---|---|---|---|
| Coffee | 1% | 1% | 1% | 1% |
| solids | | | | |
| Cocoa solids | 0.2% | 0.2% | 0.2% | 0.2% |
| Milk | 35% | 35% | 75% | 75% |
| Sodium | 0% | 0.095% | 0.0% | 0.3% |
| bicarbonate | | | | |
| Ammonium | 0.095% | 0.0% | 0.3% | 0.0% |
| bicarbonate | | | | |
| Potassium | 0.1% | 0.1% | 0.0% | 0.0% |
| citrate | | | | |
| Potassium | 0.095% | 0.095% | 0.0% | 0.0% |
| phosphate | | | | |
| Sugar | 4.8% | 4.8% | 3% | 3% |
| Water | To 100% | To 100% | To 100% | To 100% |

Product 1 is a chocolate-flavoured cappuccino beverage (which comprises 35% milk) with an amount of ammonium-salt required to adjust and maintain the pH of the beverage above pH 6 (for example, after heat treatment); in addition, potassium-salts are present. Product 1 had a pH of 6.90 when manufactured and a pH of 6.40 after heat treatment (i.e. retort sterilisation).

Product 2 is a chocolate-flavoured cappuccino beverage (which comprises 35% milk) which contains no ammonium-salt and an amount of sodium bicarbonate required to adjust and maintain the pH of the beverage above pH 6 (for example, after heat treatment).

Product 3 is a chocolate-flavoured cappuccino beverage (which comprises 75% milk) with an amount of ammonium-salt required to adjust and maintain the pH of the beverage above pH 6 (for example, after heat treatment). Product 3 had a pH of 6.90 when manufactured and a pH of 6.55 after heat treatment (i.e. retort sterilisation).

Product 4 is a chocolate-flavoured cappuccino beverage (which comprises 75% milk) which contains no ammonium-salt and an amount of sodium bicarbonate required to adjust and maintain the pH of the beverage above pH 6 (for example, after heat treatment).

### Sensorial Evaluation of the Beverages

Products 1 to 4 were subjected to tasting/viscosity testing.

(a) Sensory Comparison of Product 1 with Product 2

Product 1 had a fresh mild milk coffee flavour with a strong coffee aroma. The synergy of the coffee and cocoa was detected in a pleasing chocolate taste with coffee overtone. Product 2 had a lighter perceivable coffee aroma with a sharp metallic aftertaste over powering any perception of the chocolate and coffee note in Product 1.

(b) Sensory Comparison of Product 3 with Product 4

Product 3 had a fresh milky coffee aroma. The taste clearly represented the chocolate/coffee synergy. Product 4 had a very light coffee aroma and a very metallic and salty aftertaste.

(c) Sensory Comparison of Products 1 and 3 with Beverages Comprising Potassium Bicarbonate

Product 1 was compared with a beverage comprising identical amounts of coffee solids, cocoa solids, milk and sugar but in which potassium bicarbonate was used as a pH adjustor. Product 3 was compared with a beverage comprising identical amounts of coffee solids, cocoa solids, milk and sugar but in which potassium bicarbonate was used as a pH adjustor. Both Products 1 and 3 compared very similarly to the corresponding beverage from a sensorial viewpoint.

### Example 3

### GC-MS Analysis of Coffee Beverages Comprising Either Potassium Bicarbonate (Sample 01) or Ammonium Bicarbonate (Sample 02), Following Heat Sterilisation by Retort Heating

GC-MS (gas chromatography-mass spectroscopy) analysis was performed on two beverages, each comprising an identical amount of coffee solids, cocoa solids, milk and sugar, but in which either potassium bicarbonate (Sample 01) or ammonium bicarbonate (Sample 02) was used to adjust the pH.

The beverages were heat sterilised by retort heating and analysed by GC-MS with headspace SPME (solid phase micro-extraction), which generates a profile of the volatile and semi-volatile compounds present in the headspace of the liquid or solid sample. In particular, 5 ml of the samples were inserted in a 20 ml headspace vial and heated to 65° C. The volatile compounds were then adsorbed on a SPME fibre for 15 minutes, and the fibre then desorbed in a gas chromatograph with mass spectrometric detection (Agilent 7890 GC-5975C MS).

The GC-MS profiles of the two samples are very similar, and no significant difference was 870 identified in the peak height/area of the GC-MS of the two samples (FIG. 1-Sample 01, top panel; Sample 02, bottom panel). Accordingly, both beverages contained substantially the same volatile and semi-volatile compounds.

The majority of the products identified in the GC-MS profiles (see FIG. 1) are 875 degradation products generated by the heating of the milk component of the beverages—those flavour compounds (for example, furfuryl alcohol, pyrazines, pyridine, C3-, C5-, C7-, C9- and C11-2-ketones) are present in same amounts in both Sample 01 and 02 (see FIGS. 2 and 3).

Accordingly, no novel compounds were formed in the beverage comprising ammonium bicarbonate as a pH adjustor, indicating that the presence of ammonium bicarbonate does not generate compounds capable of adversely affecting the taste, texture or aroma of the beverage.

1. A beverage comprising a plant extract and/or a dairy product, and an amount of an ammonium-salt capable of maintaining the pH of the beverage at a predetermined pH or adjusting the pH of the beverage to a predetermined pH.

2. (canceled)

3. The beverage of claim 1, wherein maintaining the predetermined pH of the beverage comprises preventing and/or reducing acidification of the beverage.

4. The beverage of claim 1, wherein the predetermined pH is maintained when the beverage is subjected to heat treatment.

5. The beverage of claim 4, wherein the heat treatment gives an F₀ value of between 3 and 80.

6. The beverage of claim 4, wherein heat treatment comprises retort sterlization or pasteurization.

7. The beverage of claim 4, wherein said heat treatment is selected from the group consisting of: 125° C. for 25 minutes; 121° C. for 20 minutes; 71.7° C. for 15 seconds; 72° C. for 15 seconds; 72° C. for 30 seconds; 138° C. for a fraction of a second; 63° C. for 30 minutes, followed by cooling to 4° C.

8. (canceled)

9. The beverage of claim 4, wherein heat treatment comprises long-term storage in a condition comprising storage at a temperature between 30° C. and 60° C. for a time period of between 1 hour and 24 hours.

10. The beverage of claim 1, wherein said plant extract is selected from the group comprising: a coffee extract; a cocoa extract; a tea extract; a cereal extract; a vegetable extract; a fruit extract; and a herb extract, and said dairy product is selected from the group comprising: whole milk; semi-skimmed milk; skimmed milk; powdered milk; long-life milk; full-fat cream; half-fat cream; sour cream; clotted cream; and yogurt.

11. (canceled)

12. The beverage of claim 1, wherein the beverage is a coffee beverage selected from the group comprising: black coffee; milk-coffee; white coffee; and ice-coffee.

13. (canceled)

14. The beverage of claim 1, wherein the predetermined pH is pH 6 or above.

15. The beverage of claim 1, wherein the ammonium-salt is selected from the group consisting of ammonium carbonate, ammonium carbamate, ammonium bicarbonate, ammonium alginate, ammonium dihydrogen phosphate and ammonium hydrogen carbonate.

16-17. (canceled)

18. A method for maintaining or adjusting the pH of a beverage comprising a plant extract and/or a dairy product, comprising the step of adding to the beverage an amount of an ammonium-salt capable of maintaining or adjusting the pH of the beverage at a predetermined pH.

19. (canceled)

20. The method of claim 18, wherein maintaining the predetermined pH of the beverage comprises preventing and/or reducing acidification of the beverage.

21. The method of claim 18, wherein the predetermined pH is maintained when the beverage is subjected to heat treatment.

22. The method of claim 18, wherein the heat treatment gives an F₀ value of between 3 and 80.

23. The method of claim 21, wherein heat treatment comprises retort sterlization or pasteurization.

24. The method of claim 22, wherein said heat treatment is selected from the group consisting of: 125° C. for 25 minutes; 121° C. for 20 minutes; 71.7° C. for 15 seconds; 72° C. for 15 seconds; 72° C. for 30 seconds; 138° C. for a fraction of a second; 63° C. for 30 minutes, followed by cooling to 4° C.

25. The method of claim 18, wherein the step of adding to the beverage an amount of an ammonium-salt is performed before, during, or after heat treatment of the beverage.

26-38. (canceled)
